(19) United States
(12) Patent Application Publication
(10) Pub. No.: US 2008/0002174 A1
(43) Pub. Date: Jan. 3, 2008

(54) Control system for pattern generator in maskless lithography

(75) Inventor: Patricius Aloysius Jacobus Tinnemans, Hapert (NL)

Correspondence Address: STERNE, KESSLER, GOLDSTEIN & FOX P.L.L.C., 1100 NEW YORK AVENUE, N.W., WASHINGTON, DC, 20005, US

(73) Assignee: ASML Netherlands B.V., Veldhoven (NL)

(21) Appl. No.: 11/478,298

(22) Filed: Jun. 30, 2006

(51) Int. Cl. G03B 27/54

(52) U.S. Cl. 355/67; 355/53

(57) ABSTRACT

A lithographic apparatus comprises an illumination system, an array of individually controllable elements, a projection system, and a control system. The illumination system is configured to condition a radiation beam. The array of individually controllable elements is capable of modulating the cross-section of the radiation beam. The projection system is configured to project the modulated radiation beam onto a target portion of a substrate. The control system is arranged to send control signals, which control the array of individually controllable elements, such that a desired pattern is projected onto the substrate. The control system calculates the control signals using a bandwidth limited base function or a combination of more than one bandwidth limited base functions.

### BACKGROUND

1. Field of the Invention

The present invention that relates a lithographic apparatus and device manufacturing method.

2. Related Art

A lithographic apparatus is a machine that applies a desired pattern onto a substrate or part of a substrate. A lithographic apparatus can be used, for example, in the manufacture of flat panel displays, integrated circuits (ICs) and other devices involving fine structures. In a conventional apparatus, a patterning device, which can be referred to as a mask or a reticle, can be used to generate a circuit pattern corresponding to an individual layer of a flat panel display (or other device). This pattern can be transferred onto all or part of the substrate (e.g., a glass plate), by imaging onto a layer of radiation-sensitive material (e.g., resist) provided on the substrate.

Instead of a circuit pattern, the patterning device can be used to generate other patterns, for example a color filter pattern or a matrix of dots. Instead of a mask, the patterning device can be a patterning array that comprises an array of individually controllable elements. The pattern can be changed more quickly and for less cost in such a system compared to a mask-based system. However, a large number of computations are required control the individually controllable elements of the array, and this may reduce the speed of operation of the lithography, and/or increase its cost.

Therefore, what is needed is a system and method designed to overcome or mitigate the above disadvantage.

### SUMMARY

According to one embodiment of the present invention, there is provided a lithographic apparatus comprising an illumination system, an array of individually controllable elements, a projection system, and a control system. The illumination system is configured to condition a radiation beam. The array of individually controllable elements is capable of modulating the cross-section of the radiation beam. The projection system is configured to project the modulated radiation beam onto a target portion of a substrate. The control system is arranged to send control signals, which control the array of individually controllable elements, such that a desired pattern is projected onto the substrate. The control system calculates the control signals using a bandwidth limited base function or a combination of more than one bandwidth limited base function.

According to another embodiment of the invention, there is provided a method of lithography comprising the following steps. Using an array of individually controllable elements to modulate a cross-section of a radiation beam. Projecting the modulated radiation beam onto a target portion of a substrate using a projection system. The array of individually controllable elements is controlled by control signals sent from a control system, such that a desired pattern is projected onto the substrate. The control system calculates the control signals using a bandwidth limited base function or a combination of more than one bandwidth limited base functions.

In a further embodiment, the present invention provides a computer program product comprising a computer useable medium having computer program logic recorded thereon for controlling at least one processor, the computer program logic comprising computer program code modules that perform operations similar to the above-mentioned method and system embodiments.

Further embodiments, features, and advantages of the present inventions, as well as the structure and operation of the various embodiments of the present invention, are described in detail below with reference to the accompanying drawings.

### BRIEF DESCRIPTION OF THE DRAWINGS/FIGURES

The accompanying drawings, which are incorporated herein and form a part of the specification, illustrate one or more embodiments of the present invention and, together with the description, further serve to explain the principles of the invention and to enable a person skilled in the pertinent art to make and use the invention.

FIG. 1 depicts schematically a lithographic apparatus.

FIG. 2 is a simplified depiction of the lithographic apparatus of FIG. 1.

FIG. 3 shows schematically a path which may be followed during a calculation, according to one embodiment of the invention.

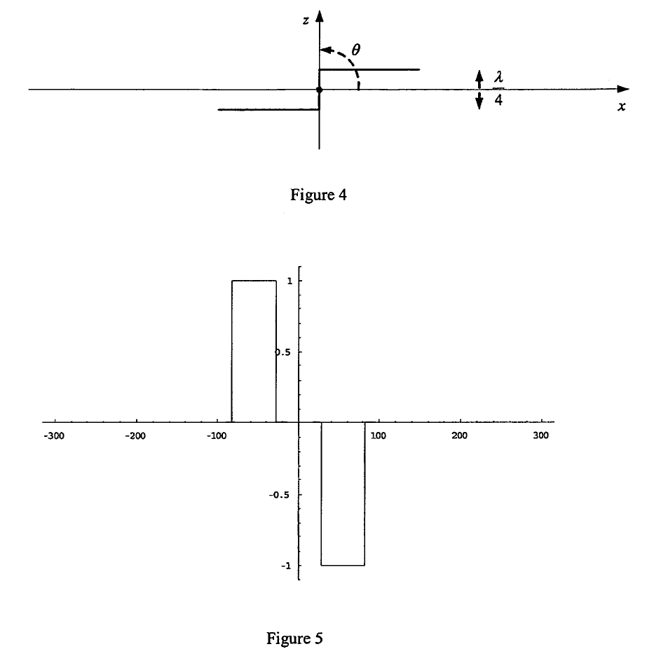

FIG. 4 shows schematically a mirror which may form part of a micromirror array, according to one embodiment of the invention.

FIGS. 5 to 8 are graphs which illustrate the representation of a pattern, according to various embodiments of the invention.

One or more embodiments of the present invention will now be described with reference to the accompanying drawings. In the drawings, like reference numbers can indicate identical or functionally similar elements. Additionally, the left-most digit(s) of a reference number can identify the drawing in which the reference number first appears.

### DETAILED DESCRIPTION

This specification discloses one or more embodiments that incorporate the features of this invention. The disclosed embodiment(s) merely exemplify the invention. The scope of the invention is not limited to the disclosed embodiment(s). The invention is defined by the claims appended hereto.

The embodiment(s) described, and references in the specification to “one embodiment”, “an embodiment”, “an example embodiment”, etc., indicate that the embodiment(s) described can include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is understood that it is within the knowledge of one skilled in the art to effect such feature, structure, or characteristic in connection with other embodiments whether or not explicitly described.

Embodiments of the invention can be implemented in hardware, firmware, software, or any combination thereof. Embodiments of the invention can also be implemented as instructions stored on a machine-readable medium, which can be read and executed by one or more processors. A machine-readable medium can include any mechanism for storing or transmitting information in a form readable by a machine (e.g., a computing device). For example, a machine-readable medium can include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions can be described herein as performing certain actions. However, it should be appreciated that such descriptions are merely for convenience and that such actions in fact result from computing devices, processors, controllers, or other devices executing the firmware, software, routines, instructions, etc.

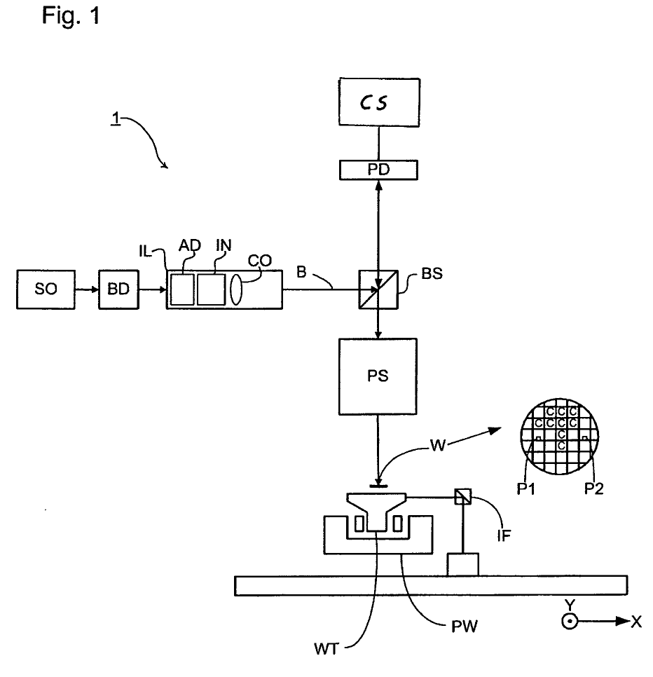

FIG. 1 schematically depicts the lithographic apparatus 1 of one embodiment of the invention. The apparatus comprises an illumination system IL, a patterning device PD, a substrate table WT, and a projection system PS. The illumination system (illuminator) IL is configured to condition a radiation beam B (e.g., UV radiation).

The substrate table WT is constructed to support a substrate (e.g., a resist-coated substrate) W and connected to a positioner PW configured to accurately position the substrate in accordance with certain parameters.

The projection system (e.g., a refractive projection lens system) PS is configured to project the beam of radiation modulated by the array of individually controllable elements onto a target portion C (e.g., comprising one or more dies) of the substrate W.

The term “projection system” used herein should be broadly interpreted as encompassing any type of projection system, including refractive, reflective, catadioptric, magnetic, electromagnetic and electrostatic optical systems, or any combination thereof, as appropriate for the exposure radiation being used, or for other factors such as the use of an immersion liquid or the use of a vacuum. Any use of the term “projection lens” herein can be considered as synonymous with the more general term “projection system.”

The projection system PS can include dynamic elements, such as a synchronous scanning mirror SSM as described below. The synchronous scanning mirror SSM can require a frequency signal F from the radiation source SO and scan velocity signal SV from the substrate table WT to function, i.e., to control a resonant frequency of the synchronous scanning mirror SSM.

The illumination system can include various types of optical components, such as refractive, reflective, magnetic, electromagnetic, electrostatic or other types of optical components, or any combination thereof, for directing, shaping, or controlling radiation.

The patterning device PD (e.g., a reticle or mask or an array of individually controllable elements) modulates the beam. In general, the position of the array of individually controllable elements will be fixed relative to the projection system PS. However, it can instead be connected to a positioner configured to accurately position the array of individually controllable elements in accordance with certain parameters.

The term “patterning device” or “contrast device” used herein should be broadly interpreted as referring to any device that can be used to modulate the cross-section of a radiation beam, such as to create a pattern in a target portion of the substrate. The devices can be either static patterning devices (e.g., masks or reticles) or dynamic (e.g., arrays of programmable elements) patterning devices. For brevity, most of the description will be in terms of a dynamic patterning device, however it is to be appreciated that a static pattern device can also be used without departing from the scope of the present invention.

It should be noted that the pattern imparted to the radiation beam may not exactly correspond to the desired pattern in the target portion of the substrate, for example if the pattern includes phase-shifting features or so called assist features. Similarly, the pattern eventually generated on the substrate may not correspond to the pattern formed at any one instant on the array of individually controllable elements. This can be the case in an arrangement in which the eventual pattern formed on each part of the substrate is built up over a given period of time or a given number of exposures during which the pattern on the array of individually controllable elements and/or the relative position of the substrate changes.

Generally, the pattern created on the target portion of the substrate will correspond to a particular functional layer in a device being created in the target portion, such as an integrated circuit or a flat panel display (e.g., a color filter layer in a flat panel display or a thin film transistor layer in a flat panel display). Examples of such patterning devices include reticles, programmable mirror arrays, laser diode arrays, light emitting diode arrays, grating light valves, and LCD arrays.

Patterning devices whose pattern is programmable with the aid of electronic means (e.g., a computer), such as patterning devices comprising a plurality of programmable elements (e.g., all the devices mentioned in the previous sentence except for the reticle), are collectively referred to herein as “contrast devices.” The patterning device comprises at least 10, at least 100, at least 1,000, at least 10,000, at least 100,000, at least 1,000,000, or at least 10,000,000 programmable elements.

A programmable mirror array can comprise a matrix-addressable surface having a viscoelastic control layer and a reflective surface. The basic principle behind such an apparatus is that addressed areas of the reflective surface reflect incident light as diffracted light, whereas unaddressed areas reflect incident light as undiffracted light. Using an appropriate spatial filter, the undiffracted light can be filtered out of the reflected beam, leaving only the diffracted light to reach the substrate. In this manner, the beam becomes patterned according to the addressing pattern of the matrix-addressable surface.

It will be appreciated that, as an alternative, the filter can filter out the diffracted light, leaving the undiffracted light to reach the substrate.

An array of diffractive optical MEMS devices (micro-electro-mechanical system devices) can also be used in a corresponding manner. In one example, a diffractive optical MEMS device is composed of a plurality of reflective ribbons that can be deformed relative to one another to form a grating that reflects incident light as diffracted light.

A further alternative example of a programmable mirror array employs a matrix arrangement of tiny mirrors, each of which can be individually tilted about an axis by applying a suitable localized electric field, or by employing piezoelectric actuation means. Once again, the mirrors are matrix-addressable, such that addressed mirrors reflect an incoming radiation beam in a different direction than unaddressed mirrors; in this manner, the reflected beam can be patterned according to the addressing pattern of the matrix-addressable mirrors. The required matrix addressing can be performed using suitable electronic means.

Another example PD is a programmable LCD array.

The lithographic apparatus can comprise one or more contrast devices. For example, it can have a plurality of arrays of individually controllable elements, each controlled independently of each other. In such an arrangement, some or all of the arrays of individually controllable elements can have at least one of a common illumination system (or part of an illumination system), a common support structure for the arrays of individually controllable elements, and/or a common projection system (or part of the projection system).

In one example, such as the embodiment depicted in FIG. 1, the substrate W has a substantially circular shape, optionally with a notch and/or a flattened edge along part of its perimeter. In another example, the substrate has a polygonal shape, e.g., a rectangular shape.

Examples where the substrate has a substantially circular shape include examples where the substrate has a diameter of at least 25 mm, at least 50 mm, at least 75 mm, at least 100 mm, at least 125 mm, at least 150 mm, at least 175 mm, at least 200 mm, at least 250 mm, or at least 300 mm. Alternatively, the substrate has a diameter of at most 500 mm, at most 400 mm, at most 350 mm, at most 300 mm, at most 250 mm, at most 200 mm, at most 150 mm, at most 100 mm, or at most 75 mm.

Examples where the substrate is polygonal, e.g., rectangular, include examples where at least one side, at least 2 sides or at least 3 sides, of the substrate has a length of at least 5 cm, at least 25 cm, at least 50 cm, at least 100 cm, at least 150 cm, at least 200 cm, or at least 250 cm.

At least one side of the substrate has a length of at most 1000 cm, at most 750 cm, at most 500 cm, at most 350 cm, at most 250 cm, at most 150 cm, or at most 75 cm.

In one example, the substrate W is a wafer, for instance a semiconductor wafer. The wafer material can be selected from the group consisting of Si, SiGe, SiGeC, SiC, Ge, GaAs, InP, and InAs. The wafer can be: a III/V compound semiconductor wafer, a silicon wafer, a ceramic substrate, a glass substrate, or a plastic substrate. The substrate can be transparent (for the naked human eye), colored, or absent a color.

The thickness of the substrate can vary and, to an extent, can depend on the substrate material and/or the substrate dimensions. The thickness can be at least 50 μm, at least 100 μm, at least 200 μm, at least 300 μm, at least 400 μm, at least 500 μm, or at least 600 μm. Alternatively, the thickness of the substrate can be at most 5000 μm, at most 3500 μm, at most 2500 μm, at most 1750 μm, at most 1250 μm, at most 1000 μm, at most 800 μm, at most 600 μm, at most 500 μm, at most 400 μm, or at most 300 μm.

The substrate referred to herein can be processed, before or after exposure, in for example a track (a tool that typically applies a layer of resist to a substrate and develops the exposed resist), a metrology tool, and/or an inspection tool. In one example, a resist layer is provided on the substrate.

The projection system can image the pattern on the array of individually controllable elements, such that the pattern is coherently formed on the substrate. Alternatively, the projection system can image secondary sources for which the elements of the array of individually controllable elements act as shutters. In this respect, the projection system can comprise an array of focusing elements such as a micro lens array (known as an MLA) or a Fresnel lens array to form the secondary sources and to image spots onto the substrate. The array of focusing elements (e.g., MLA) comprises at least 10 focus elements, at least 100 focus elements, at least 1,000 focus elements, at least 10,000 focus elements, at least 100,000 focus elements, or at least 1,000,000 focus elements.

The number of individually controllable elements in the patterning device is equal to or greater than the number of focusing elements in the array of focusing elements. One or more (e.g., 1,000 or more, the majority, or each) of the focusing elements in the array of focusing elements can be optically associated with one or more of the individually controllable elements in the array of individually controllable elements, with 2 or more, 3 or more, 5 or more, 10 or more, 20 or more, 25 or more, 35 or more, or 50 or more of the individually controllable elements in the array of individually controllable elements.

The MLA can be movable (e.g., with the use of one or more actuators) at least in the direction to and away from the substrate. Being able to move the MLA to and away from the substrate allows, e.g., for focus adjustment without having to move the substrate.

As herein depicted in FIG. 1, the apparatus is of a reflective type (e.g., employing a reflective array of individually controllable elements). Alternatively, the apparatus can be of a transmission type (e.g., employing a transmission array of individually controllable elements).

The lithographic apparatus can be of a type having two (dual stage) or more substrate tables. In such “multiple stage” machines, the additional tables can be used in parallel, or preparatory steps can be carried out on one or more tables while one or more other tables are being used for exposure.

The lithographic apparatus can also be of a type wherein at least a portion of the substrate can be covered by an “immersion liquid” having a relatively high refractive index, e.g., water, so as to fill a space between the projection system and the substrate. An immersion liquid can also be applied to other spaces in the lithographic apparatus, for example, between the patterning device and the projection system. Immersion techniques are well known in the art for increasing the numerical aperture of projection systems. The term “immersion” as used herein does not mean that a structure, such as a substrate, must be submerged in liquid, but rather only means that liquid is located between the projection system and the substrate during exposure.

Referring again to FIG. 1, the illuminator IL receives a radiation beam from a radiation source SO. The radiation source provides radiation having a wavelength of at least 5 nm, at least 10 nm, at least 11-13 nm, at least 50 nm, at least 100 nm, at least 150 nm, at least 175 nm, at least 200 nm, at least 250 nm, at least 275 nm, at least 300 nm, at least 325 nm, at least 350 nm, or at least 360 nm. Alternatively, the radiation provided by radiation source SO has a wavelength of at most 450 nm, at most 425 nm, at most 375 nm, at most 360 nm, at most 325 nm, at most 275 nm, at most 250 nm, at most 225 nm, at most 200 nm, or at most 175 nm. The radiation can have a wavelength including 436 nm, 405 nm, 365 nm, 355 nm, 248 nm, 193 nm, 157 nm, and/or 126 nm.

The source and the lithographic apparatus can be separate entities, for example when the source is an excimer laser. In such cases, the source is not considered to form part of the lithographic apparatus and the radiation beam is passed from the source SO to the illuminator IL with the aid of a beam delivery system BD comprising, for example, suitable directing mirrors and/or a beam expander. In other cases the source can be an integral part of the lithographic apparatus, for example when the source is a mercury lamp. The source SO and the illuminator IL, together with the beam delivery system BD if required, can be referred to as a radiation system.

The illuminator IL, can comprise an adjuster AD for adjusting the angular intensity distribution of the radiation beam. Generally, at least the outer and/or inner radial extent (commonly referred to as σ-outer and σ-inner, respectively) of the intensity distribution in a pupil plane of the illuminator can be adjusted. In addition, the illuminator IL can comprise various other components, such as an integrator IN and a condenser CO. The illuminator can be used to condition the radiation beam to have a desired uniformity and intensity distribution in its cross-section. The illuminator IL, or an additional component associated with it, can also be arranged to divide the radiation beam into a plurality of sub-beams that can, for example, each be associated with one or a plurality of the individually controllable elements of the array of individually controllable elements. A two-dimensional diffraction grating can, for example, be used to divide the radiation beam into sub-beams. In the present description, the terms “beam of radiation” and “radiation beam” encompass, but are not limited to, the situation in which the beam is comprised of a plurality of such sub-beams of radiation.

The radiation beam B is incident on the patterning device PD (e.g., an array of individually controllable elements) and is modulated by the patterning device. Having been reflected by the patterning device PD, the radiation beam B passes through the projection system PS, which focuses the beam onto a target portion C of the substrate W. With the aid of the positioner PW and position sensor IF2 (e.g., an interferometric device, linear encoder, capacitive sensor, or the like), the substrate table WT can be moved accurately, e.g., so as to position different target portions C in the path of the radiation beam B. Where used, the positioning means for the array of individually controllable elements can be used to correct accurately the position of the patterning device PD with respect to the path of the beam B, e.g., during a scan.

In one example, movement of the substrate table WT is realized with the aid of a long-stroke module (course positioning) and a short-stroke module (fine positioning), which are not explicitly depicted in FIG. 1. In another example, a short stroke stage may not be present. A similar system can also be used to position the array of individually controllable elements. It will be appreciated that the beam B can alternatively/additionally be moveable, while the object table and/or the array of individually controllable elements can have a fixed position to provide the required relative movement. Such an arrangement can assist in limiting the size of the apparatus. As a further alternative, which can, e.g., be applicable in the manufacture of flat panel displays, the position of the substrate table WT and the projection system PS can be fixed and the substrate W can be arranged to be moved relative to the substrate table WT. For example, the substrate table WT can be provided with a system for scanning the substrate W across it at a substantially constant velocity.

As shown in FIG. 1, the beam of radiation B can be directed to the patterning device PD by means of a beam splitter BS configured such that the radiation is initially reflected by the beam splitter and directed to the patterning device PD. It should be realized that the beam of radiation B can also be directed at the patterning device without the use of a beam splitter. The beam of radiation can be directed at the patterning device at an angle between 0 and 90°, between 5 and 85°, between 15 and 75°, between 25 and 65°, or between 35 and 55° (the embodiment shown in FIG. 1 is at a 90° angle). The patterning device PD modulates the beam of radiation B and reflects it back to the beam splitter BS which transmits the modulated beam to the projection system PS. It will be appreciated, however, that alternative arrangements can be used to direct the beam of radiation B to the patterning device PD and subsequently to the projection system PS. In particular, an arrangement such as is shown in FIG. 1 may not be required if a transmission patterning device is used.

The depicted apparatus can be used in several modes:

1. In step mode, the array of individually controllable elements and the substrate are kept essentially stationary, while an entire pattern imparted to the radiation beam is projected onto a target portion C at one go (i.e., a single static exposure). The substrate table WT is then shifted in the X and/or Y direction so that a different target portion C can be exposed. In step mode, the maximum size of the exposure field limits the size of the target portion C imaged in a single static exposure.

2. In scan mode, the array of individually controllable elements and the substrate are scanned synchronously while a pattern imparted to the radiation beam is projected onto a target portion C (i.e., a single dynamic exposure). The velocity and direction of the substrate relative to the array of individually controllable elements can be determined by the (de-) magnification and image reversal characteristics of the projection system PS. In scan mode, the maximum size of the exposure field limits the width (in the non-scanning direction) of the target portion in a single dynamic exposure, whereas the length of the scanning motion determines the height (in the scanning direction) of the target portion.

3. In pulse mode, the array of individually controllable elements is kept essentially stationary and the entire pattern is projected onto a target portion C of the substrate W using a pulsed radiation source. The substrate table WT is moved with an essentially constant speed such that the beam B is caused to scan a line across the substrate W. The pattern on the array of individually controllable elements is updated as required between pulses of the radiation system and the pulses are timed such that successive target portions C are exposed at the required locations on the substrate W. Consequently, the beam B can scan across the substrate W to expose the complete pattern for a strip of the substrate. The process is repeated until the complete substrate W has been exposed line by line.

4. Continuous scan mode is essentially the same as pulse mode except that the substrate W is scanned relative to the modulated beam of radiation B at a substantially constant speed and the pattern on the array of individually controllable elements is updated as the beam B scans across the substrate W and exposes it. A substantially constant radiation source or a pulsed radiation source, synchronized to the updating of the pattern on the array of individually controllable elements, can be used.

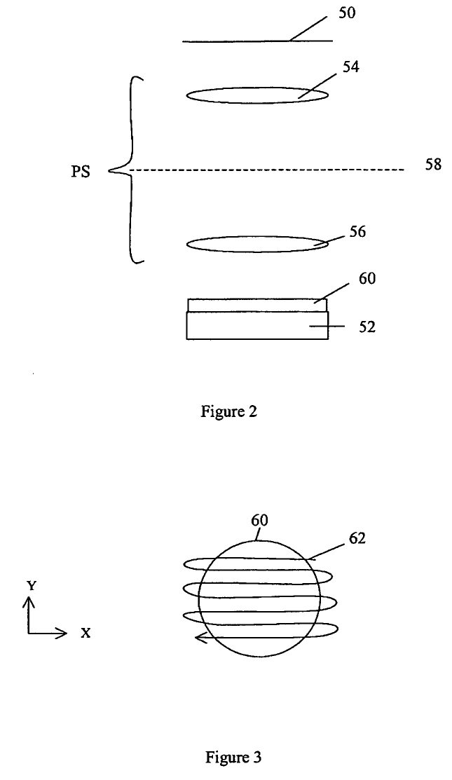

5. In pixel grid imaging mode, which can be performed using the lithographic apparatus of FIG. 2, the pattern formed on substrate W is realized by subsequent exposure of spots formed by a spot generator that are directed onto patterning device PD. The exposed spots have substantially the same shape. On substrate W the spots are printed in substantially a grid. In one example, the spot size is larger than a pitch of a printed pixel grid, but much smaller than the exposure spot grid. By varying intensity of the spots printed, a pattern is realized. In between the exposure flashes the intensity distribution over the spots is varied.

Combinations and/or variations on the above described modes of use or entirely different modes of use can also be employed.

In lithography, a pattern is exposed on a layer of resist on the substrate. The resist is then developed. Subsequently, additional processing steps are performed on the substrate. The effect of these subsequent processing steps on each portion of the substrate depends on the exposure of the resist. In particular, the processes are tuned such that portions of the substrate that receive a radiation dose above a given dose threshold respond differently to portions of the substrate that receive a radiation dose below the dose threshold. For example, in an etching process, areas of the substrate that receive a radiation dose above the threshold are protected from etching by a layer of developed resist. However, in the post-exposure development, the portions of the resist that receive a radiation dose below the threshold are removed and therefore those areas are not protected from etching. Accordingly, a desired pattern can be etched. In particular, the individually controllable elements in the patterning device are set such that the radiation that is transmitted to an area on the substrate within a pattern feature is at a sufficiently high intensity that the area receives a dose of radiation above the dose threshold during the exposure. The remaining areas on the substrate receive a radiation dose below the dose threshold by setting the corresponding individually controllable elements to provide a zero or significantly lower radiation intensity.

In practice, the radiation dose at the edges of a pattern feature does not abruptly change from a given maximum dose to zero dose even if the individually controllable elements are set to provide the maximum radiation intensity on one side of the feature boundary and the minimum radiation intensity on the other side. Instead, due to diffractive effects, the level of the radiation dose drops off across a transition zone. The position of the boundary of the pattern feature ultimately formed by the developed resist is determined by the position at which the received dose drops below the radiation dose threshold. The profile of the drop-off of radiation dose across the transition zone, and hence the precise position of the pattern feature boundary, can be controlled more precisely by setting the individually controllable elements that provide radiation to points on the substrate that are on or near the pattern feature boundary. These can be not only to maximum or minimum intensity levels, but also to intensity levels between the maximum and minimum intensity levels. This is commonly referred to as “grayscaling.”

Grayscaling provides greater control of the position of the pattern feature boundaries than is possible in a lithography system in which the radiation intensity provided to the substrate by a given individually controllable element can only be set to two values (e.g., just a maximum value and a minimum value). At least 3, at least 4 radiation intensity values, at least 8 radiation intensity values, at least 16 radiation intensity values, at least 32 radiation intensity values, at least 64 radiation intensity values, at least 128 radiation intensity values, or at least 256 different radiation intensity values can be projected onto the substrate.

It should be appreciated that grayscaling can be used for additional or alternative purposes to that described above. For example, the processing of the substrate after the exposure can be tuned, such that there are more than two potential responses of regions of the substrate, dependent on received radiation dose level. For example, a portion of the substrate receiving a radiation dose below a first threshold responds in a first manner; a portion of the substrate receiving a radiation dose above the first threshold but below a second threshold responds in a second manner; and a portion of the substrate receiving a radiation dose above the second threshold responds in a third manner. Accordingly, grayscaling can be used to provide a radiation dose profile across the substrate having more than two desired dose levels. The radiation dose profile can have at least 2 desired dose levels, at least 3 desired radiation dose levels, at least 4 desired radiation dose levels, at least 6 desired radiation dose levels or at least 8 desired radiation dose levels.

It should further be appreciated that the radiation dose profile can be controlled by methods other than by merely controlling the intensity of the radiation received at each point on the substrate, as described above. For example, the radiation dose received by each point on the substrate can alternatively or additionally be controlled by controlling the duration of the exposure of the point. As a further example, each point on the substrate can potentially receive radiation in a plurality of successive exposures. The radiation dose received by each point can, therefore, be alternatively or additionally controlled by exposing the point using a selected subset of the plurality of successive exposures.

In order to form the required pattern on the substrate, it is necessary to set each of the individually controllable elements in the patterning device to the requisite state at each stage during the exposure process. Therefore, control signals, representing the requisite states, must be transmitted to each of the individually controllable elements. In one example, the lithographic apparatus includes a controller that generates the control signals. The pattern to be formed on the substrate can be provided to the lithographic apparatus in a vector-defined format, such as GDSII. In order to convert the design information into the control signals for each individually controllable element, the controller includes one or more data manipulation devices, each configured to perform a processing step on a data stream that represents the pattern. The data manipulation devices can collectively be referred to as the “datapath.”

The data manipulation devices of the datapath can be configured to perform one or more of the following functions: converting vector-based design information into bitmap pattern data; converting bitmap pattern data into a required radiation dose map (e.g., a required radiation dose profile across the substrate); converting a required radiation dose map into required radiation intensity values for each individually controllable element; and converting the required radiation intensity values for each individually controllable element into corresponding control signals.

In order to form the pattern on the substrate, it is necessary to set each of the individually controllable elements in the patterning device to the requisite state at each stage during the exposure process. Therefore, control signals, representing the requisite states, are transmitted to each of the individually controllable elements. The lithographic apparatus includes a control system CS that generates the control signals. The pattern to be formed on the substrate can be provided to the lithographic apparatus in a vector-defined format such as GDSII. In order to convert the design information into the control signals for each individually controllable element, the control system CS includes one or more data manipulation devices, each configured to perform a processing step on a data stream that represents the pattern. The data manipulation devices can collectively be referred to as the “datapath”.

The data manipulation devices of the datapath can be configured to perform one or more of the following functions: converting vector-based design information into bitmap pattern data; converting bitmap pattern data into a required radiation dose map (namely a required radiation dose profile across the substrate); converting a required radiation dose map into required radiation intensity values for each individually controllable element; and converting the required radiation intensity values for each individually controllable element into corresponding control signals.

FIG. 2 shows schematically a micromirror array 50, projection system PS, and a substrate table 52 of a lithographic apparatus. The projection system PS comprises a first lens 54 and a second lens 56 and a field plane 58 located between the first and second lenses. A substrate 60 is provided on the substrate table 52. The micromirror array 50 is an example of the individually controllable elements referred to above, and it will be understood that other individually controllable elements may be used in place of the micromirror array 50.

During lithographic projection, at a given moment in time it will be desired to form a particular pattern on a target region of the substrate 60. The datapath calculates the pattern needed on the micromirror array 50 in order to form the desired pattern at the substrate 60. This calculation may be computationally very intensive, particularly if the optics of the projection system PS are not linear or the substrate 60 is located out of the pupil plane of the second lens 56 (this may occur for example due to unevenness of the uppermost surface of the substrate 60). In some instances the micromirror array 50 may be located out of the pupil plane of the first lens 54, further complicating the required calculation. Conventional algorithms for the determination of the pattern to be provided on the micromirror array 50 are typically complex and computationally intensive.

In one example, the pattern provided at the micromirror array 50 can be calculated using a predetermined base function, or set of base functions, which form(s) a bandwidth limited pattern. When calculating the particular pattern to be provided on the micromirror array 50, because the pattern is bandwidth limited any nonlinearity in the projection system PS may be ignored (i.e., the projection system may be treated as though it is linear). The computation of the pattern to be provided on the micromirror array 50 is thus considerably simplified and requires significantly less computational power, as compared to conventional methods. This allows a cheaper control system CS to be used and/or speeds up the calculation of control signals to be sent to the micromirror array 50.

A base function may be used that is compact in the frequency domain and in the spatial domain. The most compact function is a Gaussian, although this function may be difficult to use in practice because its amplitude never reaches zero. Alternatively, the following (two-dimensional) base function H(x, y)(or other suitable base functions) can be used:

$$H ( x , y ) = \frac{NA \cdot ( 1 - {σ}_{outer} )}{λ} \cdot \frac{{J}_{1} ( 2 \cdot π \cdot \frac{NA \cdot ( 1 - {σ}_{outer} )}{λ} \cdot \sqrt{{x}^{2} + {y}^{2}} )}{\sqrt{{x}^{2} + {y}^{2}}}$$

Where x and y are coordinates that are used to specify locations across the image plane of the projection system PS, NA is the numerical aperture of the projection system, σₒᵤₜₑᵣ is the outer radius of the illuminator IL measured in the pupil plane of the projection system PS, λ is the wavelength of the radiation passing through the projection system, and J₁(x) is a Bessel function of the first kind and the first order.

The base function is normalized so that its two dimensional surface integral is equal to one:

$${\int }_{- ∞}^{∞} {\int }_{- ∞}^{∞} \frac{NA \cdot ( 1 - {σ}_{outer} )}{λ} \cdot \frac{{J}_{1} ( 2 \cdot π \cdot \frac{NA \cdot ( 1 - {σ}_{outer} )}{λ} \cdot \sqrt{{x}^{2} + {y}^{2}} )}{\sqrt{{x}^{2} + {y}^{2}}} \cdot d x \cdot d y = 1.$$

For numerical implementation purposes, the value of the bandwidth limited base function in its central position is:

$$H ( 0 , 0 ) = π \cdot {( \frac{NA \cdot ( 1 - {σ}_{outer} )}{λ} )}^{2} .$$

The continuous two-dimensional Fourier transform of this bandwidth limited base function is:

$$\tilde{H} ( f , g ) = \{ \begin{matrix}1 , & \sqrt{{f}^{2} + {g}^{2}} \leq \frac{NA \cdot ( 1 - {σ}_{outer} )}{λ} \\ 0 , & otherwise\end{matrix} .$$

The control signals to be sent to the micromirror array 50 can be calculated as follows. A grid is applied over the pattern that is to be provided at the substrate 60. The radiation intensity required at each point on the grid is then determined as a set of intensity values, each of which is associated with a grid point. Weights may be applied to the intensity values, for example giving more importance to points that lie at the edge of pattern features. A linear matrix calculation is then used to decompose (or fit) the grid of intensity values into a matrix of bandwidth limited base functions. Once this has been done, the appropriate pattern to be provided at the micromirror array 50 may be determined.

The linear matrix calculation may be represented as follows:

w[H][A]=[b]

where w represents the weights applied to the intensity values, H is the bandwidth limited base function, A is the amplitude of the base function, and b is the pattern that is to be provided at the micromirror array 50.

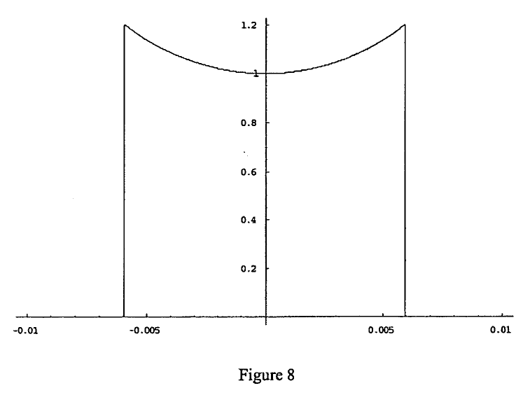

FIG. 5 represents schematically the manner in which the linear matrix calculation is used to determine the pattern to be provided at the micromirror array 50. The calculation is performed at each grid point on the substrate 60, the path between grid points scanning backwards and forwards in the x-direction over the substrate until the entire substrate (or useful areas of the substrate) have been covered.

The pattern to be provided at the micromirror array 50 is calculated in terms of (normalized) radiation amplitudes that are required at the micromirror array 50. These values can then be converted into tilt angles, which are to be assigned to mirrors of the micromirror array 50 in order to obtain desired amplitudes. The conversion can use the following expression:

$${n}_{f} ( {θ}_{y} ) = \frac{{l}_{y} \cdot λ}{π \cdot {θ}_{y}} \cdot {sin}^{2} ( \frac{{l}_{x} \cdot π \cdot {θ}_{y}}{λ} )$$

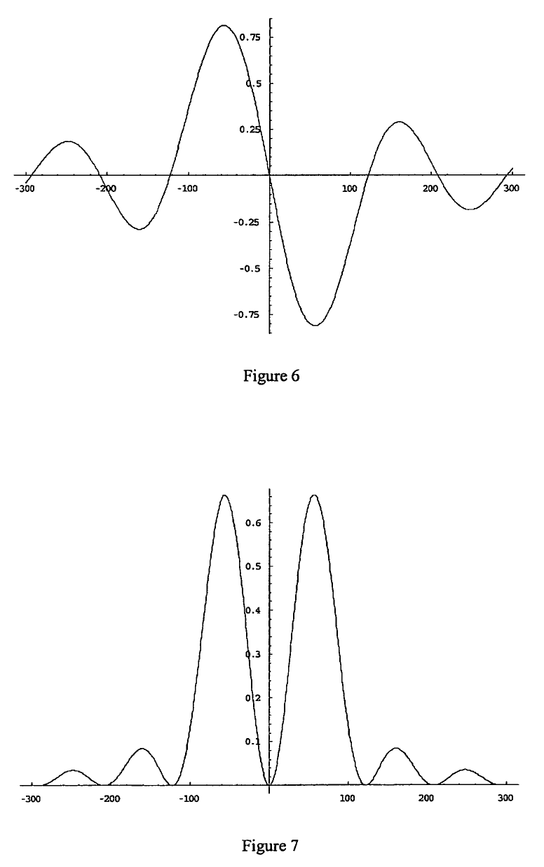

which gives the object amplitude transmittance n_{f} of a single mirror of the micromirror array 50 as a function of the mechanical tilt angle in a far field point on the z-axis. In the expression, θ_{y} is the tilt angle of the mirror around the y-axis, and the size of the mirror is lₓ in the x-direction and l_{y} in the y-direction. The expression is based on the assumption that the mechanical tilt angle is small (e.g., so that sin(θ_{y})≈θ_{y}), and that the optical reflectance of the mirror surface is 1. The mirror can include a step, as shown schematically in FIG. 4. The step has a depth of λ/4, and extends transverse to the x-direction. Mirrors of this type are referred to as phase step mirrors.

Finally, the tilt angles to be applied to the mirrors of the micromirror array 50 are converted into appropriate control signals, which are to be applied to the mirrors. The tilt angle of each mirror is determined by the control signal passed to that mirror. This mirror may, for example, be deflected by charging plates located on a substrate that supports the mirror (not shown) (the charge being determined by the control signal). Other ways in which the mirror may be tilted will be apparent to the skilled person.

The control signals are passed to the mirrors, which are then illuminated with a pulse of radiation. The radiation is patterned by the micromirror array 50 and then passes through the projection system PS to expose a pattern onto the substrate 60.

Additionally, or alternatively, the projection system PS may not be capable of resolving individual mirrors of the micromirror array 50. In other words, the separation between adjacent mirrors should be less than the resolution of the projection system PS. The separation between the mirrors may be measured as the distance between center points of diagonally adjacent mirrors. This requirement may alternatively be expressed by saying that the Nyquist frequency of the mirrors should fall outside of the pupil of the projection system PS for all incident plane waves from the illuminator IL of the lithographic apparatus (including waves incident at an angle, for example dipole illumination). This avoids aliasing of the pattern on the micromirror array 50 onto the substrate 60. The pitch p of the mirrors (i.e., separation between them mirrors) should satisfy the following condition:

$$p \leq \frac{1}{2} \cdot \frac{λ}{NA \cdot ( 1 + {σ}_{outer} )}$$

Although the above description refers to applying weights w to the intensity values, it is not essential that this is done. The embodiment of the invention may still operate without weights w being applied.

An alternative bandwidth limited function Hᵢ(f,g), which may be used in place of the bandwidth limited function described above, is:

$${\tilde{H}}_{i} ( f , g ) = \{ \begin{matrix}\begin{matrix} \frac{10}{32} + \frac{15}{32} \cdot cos ( π \cdot \frac{\sqrt{{f}^{2} + {g}^{2}}}{{f}_{0}} ) + \frac{6}{32} \cdot cos \\ ( 2 \cdot π \cdot \frac{\sqrt{{f}^{2} + {g}^{2}}}{{f}_{0}} ) + \frac{1}{32} \cdot cos ( 3 \cdot π \cdot \frac{\sqrt{{f}^{2} + {g}^{2}}}{{f}_{0}} ) ,\end{matrix} & \sqrt{{f}^{2} + {g}^{2}} \leq {f}_{0} \\ 0 , & otherwise\end{matrix} .$$

f and g are dimensions in frequency space, e.g., similar to x and y in normal space, f₀ is the cut-off frequency, which depends upon optical properties of the projection system and on the wavelength:

$${f}_{0} = \frac{NA \cdot ( 1 - {σ}_{outer} )}{λ}$$

This function Hᵢ(x, y) can have the following truncated continuous two-dimensional Fourier transform:

$${H}_{i} ( x , y ) = \{ \begin{matrix}\begin{matrix} \frac{\begin{matrix}- i \cdot \frac{10}{32} \cdot exp ( - i \cdot 2 \cdot π \cdot {f}_{0} \cdot \sqrt{{x}^{2} + {y}^{2}} ) \cdot \\ ( - 1 + exp ( i \cdot 4 \cdot π \cdot {f}_{0} \cdot \sqrt{{x}^{2} + {y}^{2}} ) )\end{matrix}}{2 \cdot π \cdot \sqrt{{x}^{2} + {y}^{2}}} + \\ \frac{\begin{matrix}2 \cdot \frac{15}{32} \cdot {f}_{0} \cdot cos ( π \cdot {f}_{0} \cdot \sqrt{{x}^{2} + {y}^{2}} ) \cdot \\ sin ( π \cdot {f}_{0} \cdot \sqrt{{x}^{2} + {y}^{2}} )\end{matrix}}{π - 2 \cdot π \cdot {f}_{0} \cdot \sqrt{{x}^{2} + {y}^{2}}} + \\ {f}_{0} \cdot sin ( 2 \cdot π \cdot {f}_{0} \cdot \sqrt{{x}^{2} + {y}^{2}} ) \cdot ( \begin{matrix}\frac{- \frac{15}{32}}{π + 2 \cdot π \cdot {f}_{0} \cdot \sqrt{{x}^{2} + {y}^{2}}} + \\ \frac{4 \cdot \frac{1}{32} \cdot {f}_{0} \cdot \sqrt{{x}^{2} + {y}^{2}}}{9 \cdot π - 4 \cdot π \cdot {f}_{0}^{2} \cdot ( {x}^{2} + {y}^{2} )} + \\ \frac{\frac{6}{32} \cdot {f}_{0} \cdot \sqrt{{x}^{2} + {y}^{2}}}{- π + π \cdot {f}_{0}^{2} \cdot ( {x}^{2} + {y}^{2} )}\end{matrix} ) ,\end{matrix} & \sqrt{{x}^{2} + {y}^{2}} \leq \frac{β}{{f}_{0}} \\ 0 , & otherwise\end{matrix}$$

where β=3 . . . 6 is considered to a practical truncation factor.

The above described example assumes a circularly symmetrical projection system PS pupil. However, the invention may still be used if this assumption is not satisfied.

Although the invention has been described in terms of a single micromirror array 50, the lithographic apparatus described above may include more than one micromirror array. For example, several micromirror arrays may be provided. They may be, for example, arranged in a “chess board” pattern. The micromirror arrays may be used in parallel, being simultaneously illuminated with radiation, and thereby simultaneously forming several patterned areas on the substrate.

Although the description uses the term “bandwidth limited,” it will be appreciated that the equivalent term “frequency limited” alternatively be used.

The continuous Fourier transform referred to above is:

$$\tilde{F} ( f , g ) = {\int }_{- ∞}^{∞} {\int }_{- ∞}^{∞} F ( x , y ) \cdot exp ( - i \cdot 2 \cdot π ( f \cdot x + g \cdot y ) ) \cdot d x \cdot d y$$

which has an inverse transform:

$$F ( x , y ) = {\int }_{- ∞}^{∞} {\int }_{- ∞}^{∞} \tilde{F} ( f , g ) \cdot exp ( i \cdot 2 \cdot π ( f \cdot x + g \cdot y ) ) \cdot d f \cdot d g$$

The calculations referred to above are based upon the assumption of (quasi) full coherent imaging of the object (amplitude transmittance), by means of a projection system with a numerical aperture that equals NA·(1−σₒᵤₜₑᵣ) Where σₒᵤₜₑᵣ is the outer radius of the illuminator IL measured in the pupil plane of the projection system PS.

Although specific reference may be made in this text to the use of lithographic apparatus in the manufacture of a specific device (e.g. an integrated circuit or a flat panel display), it should be understood that the lithographic apparatus described herein may have other applications. Applications include, but are not limited to, the manufacture of integrated circuits, integrated optical systems, guidance and detection patterns for magnetic domain memories, flat-panel displays, liquid-crystal displays (LCDs), thin-film magnetic heads, micro-electromechanical devices (MEMS), etc. Also, for instance in a flat panel display, the present apparatus may be used to assist in the creation of a variety of layers, e.g. a thin film transistor layer and/or a color filter layer.

While specific embodiments of the invention have been described above, it will be appreciated that the invention may be practiced otherwise than as described. For example, the invention may take the form of a computer program containing one or more sequences of machine-readable instructions describing a method as disclosed above, or a data storage medium (e.g. semiconductor memory, magnetic or optical disk) having such a computer program stored therein.

Having described specific embodiments of the present invention, it will be understood that many modifications thereof will readily appear or may be suggested to those skilled in the art, and it is intended therefore that this invention is limited only by the spirit and scope of the following claims.

The following is a discussion of an algorithm that may be used to decompose (or fit) a desired pattern into a sum of bandwidth limited base functions (in the image plane). The bandwidth limited function corresponds with that described above. The desired pattern will be referred to as the aerial image electric field amplitude. The following are noted. The pattern shall be completely composed out of the bandwidth limited impulse response function that we have defined (since this is the steepest/narrowest function that propagates through the optical system linearly). The normalized image log slope shall be as high as possible (which optimizes the process window).

The image features are not taken into account individually, as the influence of this bandwidth limited impulse response function is at least several critical dimensions wide, due to the uncertainty principle. (Thus some form of optical proximity correction is required.) The (least squares) residual of the fit allows for fitting of a bandwidth limited function (the sum of all impulse response functions) to a non bandwidth limited function (the desired aerial image electric field amplitude). The theorem of Parseval states that:

$${\int }_{- ∞}^{∞} {\int }_{- ∞}^{∞} {\vert F ( x , y ) \vert}^{2} \cdot d x \cdot d y = {\int }_{- ∞}^{∞} {\int }_{- ∞}^{∞} {\vert \tilde{F} ( f , g ) \vert}^{2} \cdot d f \cdot d g .$$

If this theorem is applied, the least squares residual of the fit (in the spatial domain) may not become zero (due to the unmatched high frequency part). For this reason a least squares fit (with equal weights, and an equidistant grid) may not produce the most optimal fit. (The residual will not be close to zero, and the important and less important areas are weighed equally.) The fit may be implemented in one or more of the following ways.

A deconvolution filter. This performs a least square fit with equal weights. As discussed the result will not be optimal, however from a calculation point of view this algorithm is efficient.

In a linear program (both constrained and unconstrained), its merit function should be a linear function. This is may be less suitable than the deconvolution filter.

Weighed unconstrained least squares fit on a non-uniform grid, with Tikhonov regularization. This algorithm is a robust/flexible candidate. It may provide a useful tradeoff between speed, robustness, simplicity, flexibility and performance.

### Deconvolution Filter

A least squares fit with equal weights can be implemented using a deconvolution filter. As discussed in the previous paragraph, this algorithm may not result in the best possible fit, but it can be implemented very efficiently. The aerial image electric field amplitude E_{f}(x,y) that is to be fitted using the bandwidth limited impulse response function H(x,y) is as follows

$${E}_{f} ( x , y ) = {\sum }_{m} {\sum }_{n} A ( {x}_{m} , {y}_{n} ) \cdot H ( x - {x}_{m} , y - {y}_{n} ) .$$

A(xₘ,yₙ) is the amplitude of the bandwidth limited impulse response function at location (xₘ,yₙ). Note that in this paragraph it is assumed that the projection optics ais free of aberrations/distortions. Thus the bandwidth limited impulse response function H(x,y) will be equal in the object and image planes (i.e. in the plane of the substrate 60 and of the micromirror array 50). Fitting the aerial image electric field amplitude A(xₘ,yₙ) so that the following sum is minimized involves:

$${min}_{A ( {x}_{m} , {y}_{n} )} {\vert {E}_{d} ( x , y ) - {E}_{f} ( x , y ) \vert}_{p} .$$

Where E_{d}(x,y) is the desired aerial image electric field amplitude. To perform this fit, a merit function (quality parameter of the fit, which is to be minimized) can be used, for example the 2-norm, p=2, which is also known as a least square fit. The choice for a least square fit, with equal weights, makes a computationally efficient algorithm, described below, possible. When using this simple algorithm however, the dose to clear might not be exactly at the position desired.

Turning to a simple one-dimensional case, a pattern of two dense lines is the desired image electric field. The lines are one critical dimension wide, separated by one critical dimension from each other, and are in an alternating phase configuration. The electric field is shown in FIG. 5. The electric field is normalized, and a critical dimension of 55 nanometers is used.

Each critical dimension wide line in the pattern is replaced by one bandwidth limited impulse response function. FIG. 6 shows the result of doing this. FIG. 6 represents both the object and the aerial image electric field (since it is properly frequency limited). In other words, FIG. 6 represents the desired pattern at the substrate 60 and also the pattern to be applied to the micromirror array 60.

Calculating the aerial image intensity gives the result shown in FIG. 7.

Generalizing this one-dimensional example above, for the two-dimensional case follows. If the object amplitude transmittance is frequency limited then the object electric field equals the aerial image electric field, \tilde{E}(f,g)=Õ(f,g). If it is desired to replace image features (in the desired aerial image electric field) that are one critical dimension wide, this can be done as follows

$$\tilde{E} ( f , g ) \cdot \frac{\tilde{H} ( f , g )}{\tilde{G} ( f , g )} = \tilde{O} ( f , g ) .$$

\tilde{G}(f,g) is a circularly symmetrical function representing a feature that is one critical dimension in diameter. The function \tilde{G}(f,g) is circularly symmetrical, as what pattern orientations will be present may not be known. The two possible choices for this function are the following. A sinc( ) function, in which the radial coordinate is used as an argument. A Bessel function of the first order and the first kind, in which the radial coordinate is used as an argument. Since image features are rectangular, the first option is chosen.

To define the function \tilde{G}(f,g), the following one dimensional Fourier transform pair can be used:

$$\frac{1}{CD} \cdot Π ( \frac{x}{CD} ) ↔ sin c ( CD \cdot f ) .$$

The CD is the critical dimension. Note that in the limit, where CD→0, both the right and left hand side of this Fourier transform pair equal the Dirac delta pulse function (in both domains). The function \tilde{G}(f,g) is now defined as:

\tilde{G}(f,g)=sinc(CD·\sqrt{f²+g²}).

Referring to the previous expression and reorder, the result is:

$$\tilde{O} ( f , g ) = \tilde{E} ( f , g ) \cdot \frac{\tilde{H} ( f , g )}{\tilde{G} ( f , g )} .$$

This result can be used to calculate the object amplitude transmittance, given the desired aerial image electric field. The quotient

$$\frac{\tilde{H} ( f , g )}{\tilde{G} ( f , g )}$$

is in fact a deconvolution kernel. If the definition of \tilde{H}(f,g) and \tilde{G}(f,g) are inserted in it, the following results:

$$\frac{\tilde{H} ( f , g )}{\tilde{G} ( f , g )} = \{ \begin{matrix}\frac{1}{sin c ( CD \cdot \sqrt{{f}^{2} + {g}^{2}} )} , & \sqrt{{f}^{2} + {g}^{2}} \leq \frac{NA \cdot ( 1 - {σ}_{outer} )}{λ} \\ 0 , & otherwise\end{matrix}$$

Note that for normal values of NA, σₒᵤₜₑᵣ, λ and CD, the expression above does not become singular.

FIG. 8 shows the deconvolution kernel (one-dimensional) for the following conditions,

NA·(1−σₒᵤₜₑᵣ)=1.35·(1−0.15)[−],

λ=193 [nm],

CD=55 [nm].

The following explains the weighed unconstrained least squares fit on a non-uniform grid, with Tikhonov regularization. First, the aerial image electric field amplitude E_{f}(x,y) is decomposed, using the bandwidth limited impulse response function in the image plane Hᵢ(x,y), as follows:

$${E}_{f} ( x , y ) = {\sum }_{m} {\sum }_{n} A ( {x}_{m} , {y}_{n} ) \cdot {H}_{i} ( x - {x}_{m} , y - {y}_{n} ) .$$

Where A(xₘ,yₙ) is the amplitude of the bandwidth limited impulse response function at location (xₘ,yₙ). An assumption is made that the projection optics is not free of aberrations and/or distortions. Thus the bandwidth limited impulse response function will be different in the object and image planes. Now the aerial image electric field amplitude A(xₘ,yₙ) is fitted (fit), so that the following sum is minimized:

$${min}_{A ( {x}_{m} , {y}_{n} )} {\vert {E}_{d} ( x , y ) - {E}_{f} ( x , y ) \vert}_{p} .$$

Where E_{d}(x,y) is the desired aerial image electric field amplitude. A matrix is defined as follows:

A(x,y;m,n)=w(x,y)·Hᵢ(x−xₘ,y−yₙ).

The column vector is defined as follows:

x(m,n)=A(xₘ,yₙ).

The column vector is also defined as follows:

b(x,y)=w(x,y)·E_{d}(x,y).

w(x,y) is the fit weight that is to be applied to the grid position (x,y). A minimum norm (weighed least squares) solution

$${min}_{x} {\vert Ax - b \vert}_{2}$$

of this linear problem can be found by mean of the analytical solution:

x=(A^{T}·A)⁻¹·A^{T}·b.

In case of Tikhonov regularization minimization of the function

$${min}_{x} ( {( {\vert Ax - b \vert}_{2} )}^{2} + δ \cdot {( {\vert x \vert}_{2} )}^{2} )$$

is desired. This Tikhonov regularization problem has the analytical solution:

x=(A^{T}·A+δ·I)⁻¹·A^{T}·b.

δ is the regularization constant and where I is the identity matrix.

### CONCLUSION

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

It is to be appreciated that the Detailed Description section, and not the Summary and Abstract sections, is intended to be used to interpret the claims. The Summary and abstract sections can set forth one or more, but not all exemplary embodiments of the present invention as contemplated by the inventor(s), and thus, are not intended to limit the present invention and the appended claims in any way.

What is claimed is:

1. A lithographic apparatus, comprising:
an illumination system configured to condition a radiation beam;
an array of individually controllable elements capable of patterning the radiation beam;
a projection system configured to project the patterned beam onto a target portion of the substrate; and
a control system arranged to send control signals, which control the array of individually controllable elements, such that a desired pattern is projected onto the substrate, the control system configured to calculate the control signals using a bandwidth limited base function or a combination of more than one bandwidth limited base function.

2. The lithographic apparatus of claim 1, wherein the bandwidth limited base function H(x, y) comprises:
$$H ( x , y ) = \frac{NA \cdot ( 1 - {σ}_{outer} )}{λ} \cdot \frac{{J}_{1} ( 2 \cdot π \cdot \frac{NA \cdot ( 1 - {σ}_{outer} )}{λ} \cdot \sqrt{{x}^{2} + {y}^{2}} )}{\sqrt{{x}^{2} + {y}^{2}}}$$
wherein:
x and y are coordinates that are used to specify locations across the image plane of the projection system PS,
NA is the numerical aperture of the projection system,
σₒᵤₜₑᵣ is the outer radius of an illuminator IL measured in a pupil plane of the projection system PS,
λ is the wavelength of the radiation passing through the projection system, and
J₁(x) is a Bessel function of the first kind and the first order.

3. The lithographic apparatus of claim 1, wherein the bandwidth limited base function Hᵢ(F,g) comprises:
$${\tilde{H}}_{i} ( f , g ) = \{ \begin{matrix}\begin{matrix}\frac{10}{32} + \frac{15}{32} \cdot cos ( π \cdot \frac{\sqrt{{f}^{2} + {g}^{2}}}{{f}_{0}} ) + \frac{6}{32} \cdot cos \\ ( 2 \cdot π \cdot \frac{\sqrt{{f}^{2} + {g}^{2}}}{{f}_{0}} ) + \frac{1}{32} \cdot cos ( 3 \cdot π \cdot \frac{\sqrt{{f}^{2} + {g}^{2}}}{{f}_{0}} ) ,\end{matrix} & \sqrt{{f}^{2} + {g}^{2}} \leq {f}_{0} \\ 0 , & otherwise\end{matrix} .$$
wherein:
f and g are dimensions in frequency space, and
f₀ is the cut-off frequency.

4. A method of lithography, comprising:
calculating control signals using a bandwidth limited base function or a combination of more than one bandwidth limited base function;
controlling an array of individually controllable elements using the control signals;
patterning a radiation beam using the controlled array of individually controllable elements; and
projecting the patterned radiation beam onto a target portion of a substrate.

5. The method of claim 4, wherein the bandwidth limited base function H(x,y) comprises:
$$H ( x , y ) = \frac{NA \cdot ( 1 - {σ}_{outer} )}{λ} \cdot \frac{{J}_{1} ( 2 \cdot π \cdot \frac{NA \cdot ( 1 - {σ}_{outer} )}{λ} \cdot \sqrt{{x}^{2} + {y}^{2}} )}{\sqrt{{x}^{2} + {y}^{2}}}$$
wherein:
x and y are coordinates that are used to specify locations across the image plane of the projection system PS,
NA is the numerical aperture of the projection system,
σₒᵤₜₑᵣ is the outer radius of an illuminator IL measured in a pupil plane of the projection system PS,
λ is the wavelength of the radiation passing through the projection system, and
J₁(x) is a Bessel function of the first kind and the first order.

6. The method of claim 4, wherein the bandwidth limited base function Hᵢ(f g) comprises:
$${\tilde{H}}_{i} ( f , g ) = \{ \begin{matrix}\begin{matrix}\frac{10}{32} + \frac{15}{32} \cdot cos ( π \cdot \frac{\sqrt{{f}^{2} + {g}^{2}}}{{f}_{0}} ) + \frac{6}{32} \cdot cos \\ ( 2 \cdot π \cdot \frac{\sqrt{{f}^{2} + {g}^{2}}}{{f}_{0}} ) + \frac{1}{32} \cdot cos ( 3 \cdot π \cdot \frac{\sqrt{{f}^{2} + {g}^{2}}}{{f}_{0}} ) ,\end{matrix} & \sqrt{{f}^{2} + {g}^{2}} \leq {f}_{0} \\ 0 , & otherwise\end{matrix}$$
wherein:
f and g are dimensions in frequency space, and
f₀ is the cut-off frequency.

7. A computer program product comprising a computer useable medium having computer program logic stored thereon for controlling at least one processor, the computer program logic comprising:
first computer program code means for calculating control signals using a bandwidth limited base function or a combination of more than one bandwidth limited base function;
second computer program code means for controlling an array of individually controllable elements using the control signals;
wherein a radiation beam is patterned using the controlled array of individually controllable elements; and
wherein the patterned beam is projected onto a target portion of a substrate.

8. The computer program product of claim 7, wherein the first computer program code means for calculating control signals uses the bandwidth limited base function H(x,y) comprises:
$$H ( x , y ) = \frac{NA \cdot ( 1 - {σ}_{outer} )}{λ} \cdot \frac{{J}_{1} ( 2 \cdot π \cdot \frac{NA \cdot ( 1 - {σ}_{outer} )}{λ} \cdot \sqrt{{x}^{2} + {y}^{2}} )}{\sqrt{{x}^{2} + {y}^{2}}}$$
wherein:
x and y are coordinates that are used to specify locations across the image plane of the projection system PS,
NA is the numerical aperture of the projection system,
σₒᵤₜₑᵣ is the outer radius of an illuminator IL measured in a pupil plane of the projection system PS,
λ is the wavelength of the radiation passing through the projection system, and
J₁(x) is a Bessel function of the first kind and the first order.

9. The computer program product of claim 7, wherein the first computer program code means for calculating control signals uses the bandwidth limited base function Hᵢ(f,g) comprises:
$${\tilde{H}}_{i} ( f , g ) = \{ \begin{matrix}\begin{matrix}\frac{10}{32} + \frac{15}{32} \cdot cos ( π \cdot \frac{\sqrt{{f}^{2} + {g}^{2}}}{{f}_{0}} ) + \frac{6}{32} \cdot cos \\ ( 2 \cdot π \cdot \frac{\sqrt{{f}^{2} + {g}^{2}}}{{f}_{0}} ) + \frac{1}{32} \cdot cos ( 3 \cdot π \cdot \frac{\sqrt{{f}^{2} + {g}^{2}}}{{f}_{0}} ) ,\end{matrix} & \sqrt{{f}^{2} + {g}^{2}} \leq {f}_{0} \\ 0 , & otherwise\end{matrix}$$
wherein:
f and g are dimensions in frequency space, and
f₀ is the cut-off frequency.
